(19) United States
(12) Patent Application Publication
(10) Pub. No.: US 2011/0278516 A1
(43) Pub. Date: Nov. 17, 2011

(54) Vehicle lift

(76) Inventor: Brad Christian, San Clemente, CA (US)

(21) Appl. No.: 12/800,393

(22) Filed: May 14, 2010

(51) Int. Cl. B66F 7/06; B66F 7/08

(52) U.S. Cl. 254/91

(57) ABSTRACT

The present invention is a vehicle lift. In particular, the present invention is directed to a vehicle lift that can be mounted to the rear of a vehicle or be used as a stand-alone device to lift vehicles. The preferred embodiment comprises a vehicle platform supported by a first lifting arm and a second lifting arm. The lifting arms are mounted to shafts mounted on gears. Each shaft and lifting arm has a corresponding castellated end. A star plate attaches to the shaft, fitting within the castellated ends, and joins the shaft and lifting arm. A chain engages the gears and comprises two segments joined by adjustment rods. The rods adjust chain tension and gear timing. The chain is connected to an arm of a drive. When the arm extends, it moves the chain that rotates the gears and lifting arms and lifts the platform.

### TECHNICAL FIELD

The present invention is a vehicle lift. In particular, the present invention is directed to a vehicle lift that can be mounted to the rear of a vehicle, such as a passenger vehicle, truck, or recreational vehicle, or be used as a stand-alone device to lift vehicles such as mobility scooters, motorcycles, all-terrain vehicles and scooters.

### BACKGROUND ART

A number of different vehicle lifts exist. However, these lifts often are heavy and difficult to operate and require significant space for operation extending behind a master vehicle, such as an RV or truck. Said lifts need sizable power plants to lift vehicles. Many lifts are either cable or light duty gear driven that are either not powerful enough to lift heavier loads or do not allow for a variety of cargo. These lifts also require complex locking mechanisms to secure the lifted vehicles in place. Accordingly, a vehicle lift is needed that is lockable, operates in a more confined space and makes an efficient use of lifting power.

### SUMMARY OF THE INVENTION

The present invention is a vehicle lift. In particular, the present invention is directed to a vehicle lift that can be mounted to the rear of a vehicle or be used as a stand-alone device to lift vehicles. The preferred embodiment comprises a vehicle platform supported by a first lifting arm and a second lifting arm. The lifting arms are mounted to shafts mounted on gears. Each shaft and lifting arm has a corresponding castellated end. A star plate attaches to the shaft, fitting within the castellated ends, and joins the shaft and lifting arm. A chain engages the gears and comprises two segments joined by adjustment rods. The rods adjust chain tension and gear timing. The chain is connected to an arm of a drive. When the arm extends, it moves the chain that rotates the gears and lifting arms and lifts the platform.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a perspective side view of a preferred embodiment of the invention with a shop stand configuration;

FIG. 2a is a partial cut-away view of a preferred embodiment of the invention with a vehicle hitch configuration in the raised position;

FIG. 2b is a rear perspective view of a preferred embodiment of the cam lock in the locked position;

FIG. 3 is a partial exploded side view of a preferred embodiment of the lifting arm and shaft with castellated ends and star plate;

FIG. 4 is a front perspective view of a preferred embodiment of a lifting arm bolted to a shaft with a star plate;

FIG. 5 is a front view of a preferred embodiment of a star plate;

FIG. 6 is a partial rear perspective view of a preferred embodiment of the locking bar and cam lock in the locked position;

FIG. 7 is a perspective view of a preferred embodiment of the cam lock;

FIG. 8 is a perspective view of a preferred embodiment of the adjustment rod; and,

FIG. 9 is a partial exploded perspective view of a preferred embodiment of the invention with a vehicle mount configuration.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a vehicle lift.

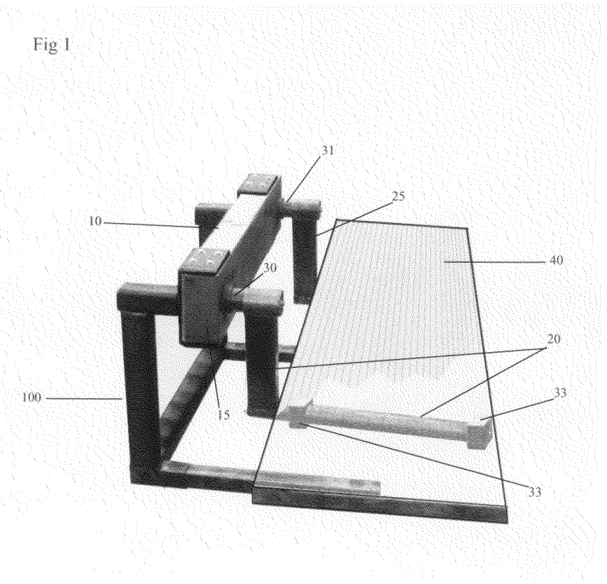

Referring now to FIG. 1, a preferred embodiment of the vehicle lift is shown. The vehicle lift 10 is shown in a shop stand configuration with a vehicle platform 40 in the lowered position. A drive box 15 is mounted to a shop stand 100. A first lifting arm 20 is mounted to a first shaft 30 extending from the drive box 15. A second lifting arm 25 is mounted to a second shaft 31 extending from the drive box 15. The lifting arms 20 and 25 are preferably inserted into platform mounts 33 on the underside of the platform 40. The arms 20 and 25 support the vehicle platform 40. The vehicle platform 40 in FIG. 1 is shown as a single ramp. The platform 40 is preferably wide enough for a mobility scooter or a single motorcycle or scooter tire to roll onto the ramp 40. The platform 40 is preferably long enough so both front and back tires of a mobility scooter or a motorcycle or other vehicle fit on the platform 40. Alternately, the platform 40 can be wide enough for the side-by-side front or rear tires of a four-wheeled vehicle. Another alternative is that a second platform (not shown) could be placed on the lifting arms 20 and 25 with the first platform 40 to accommodate four-wheeled vehicles or other cargo. Another alternative for the platform 40 is that the platform 40 is configured to accommodate wheelchairs.

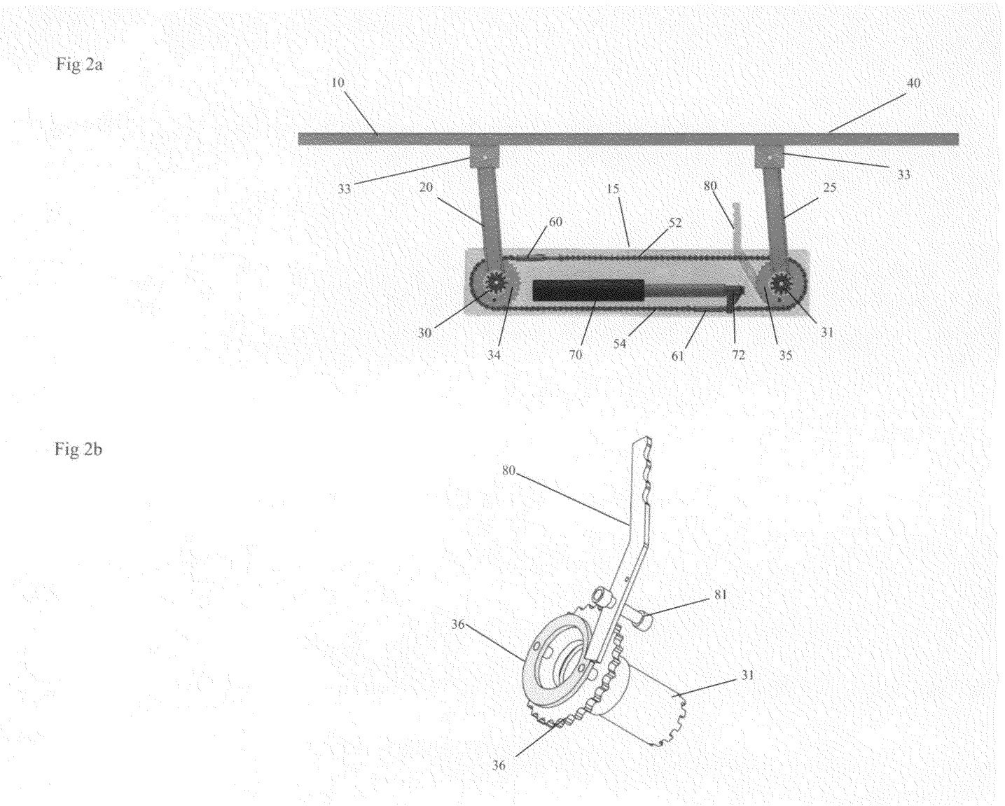

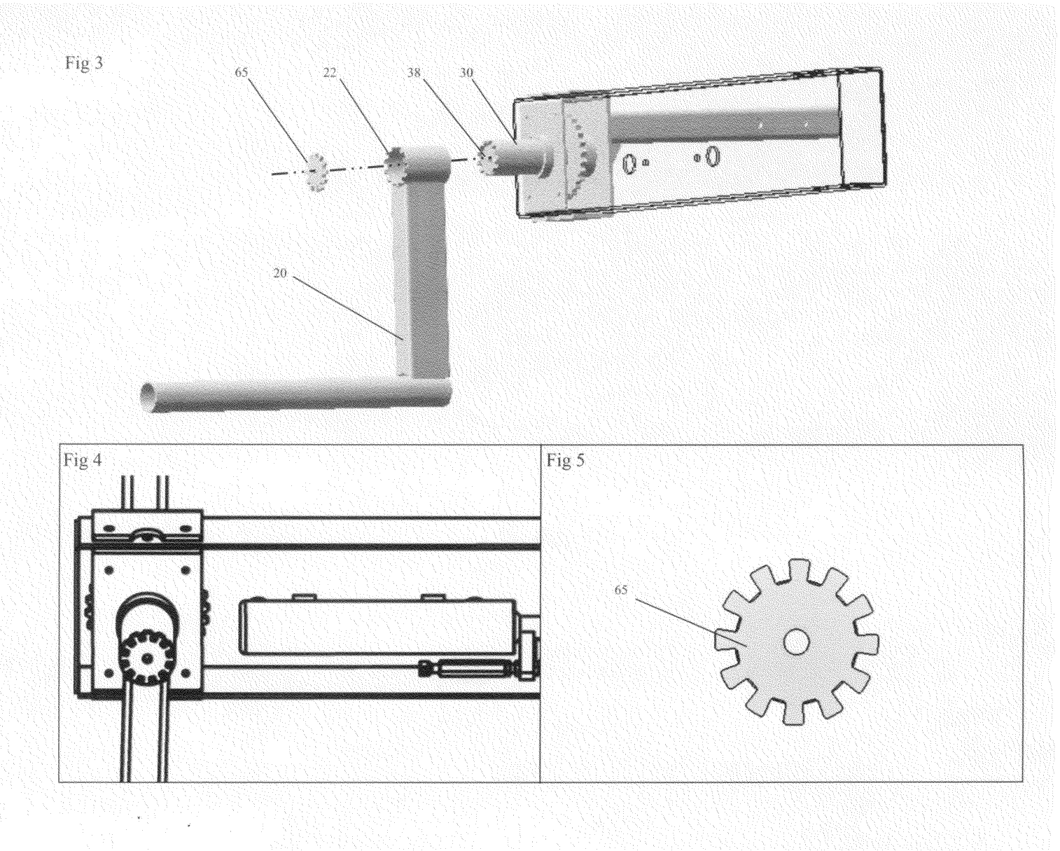

Referring now to FIG. 2a, a partial cut-away view of the vehicle lift 10 is shown. The vehicle lift 10 is shown in a vehicle mount configuration with the vehicle platform 40 in a raised position. The embodiment shown in FIG. 2a preferably is mountable to the rear of a vehicle such as a recreation vehicle (RV), a sport utility vehicle (SUV) or a truck or some other vehicle at the trailer hitch. As shown, a first lifting arm 20 and a second lifting arm 25 support the vehicle platform 40. The first lifting arm 20 is mounted to first shaft 30 extending from the drive box 15. The second lifting arm 25 is mounted to a second shaft 31 extending from the drive box 15. The first shaft 30 is mounted to a first gear 34 and the second shaft 31 is mounted to a second gear 35.

A chain 50 connects the first and second gears 34 and 35 and engages the teeth of these gears 34 and 35. The chain 50 preferably has two segments 52 and 54. The segments 52 and 54 are preferably joined together by a first adjustment rod 60 and a second adjustment rod 61. In the embodiment shown in FIG. 2, a linkage arm 72 of a hydraulic ram 70 is attached to the chain 50. The hydraulic ram 70 is preferably a double acting single rod ended hydraulic cylinder where the pressure from the fluid is applied in both directions. The ram 70 shown is preferably a 3.1 160 amp 12 v electric over hydraulic motor and pump powered by a vehicle battery or AC power from an outlet. Preferably, the ram can be operated by local and/or remote controls. Alternately, an electric actuator or other type of drive can be used. The arm 72 is shown in an extended position in FIG. 2a and preferably has a 10-inch stroke. Accordingly, when the linkage arm 72 of the hydraulic ram 70 extends, the arm 72 moves the chain 50 that rotates the gears 34 and 35. The rotation of the gears 34 and 35 rotates the shafts 30 and 31 respectively. The rotation of the shafts 30 and 31 rotates the lifting arms 20 and 25 in the platform mounts 33. The lifting arms 20 and 25 consequently move the vehicle platform 40, preferably from a lowered position to a raised position. Preferably, the extension of the linkage arm 72 rotates the gears 34 and 35 one hundred and eighty degrees. Preferably, retraction of the arm 72, rotates the gears 34 and 35 in the opposite direction and lowers the platform 40.

As shown in FIG. 2b, a locking bar 80 is shown in the locked position. As shown, a cam lock 36 is mounted behind the second gear 35 and around the second shaft 31. The locking bar 80 is preferably mounted to the drive box 15 at pivot 81. A preferred embodiment of the locking bar 80 and cam lock 36 arrangement is also shown in FIG. 6.

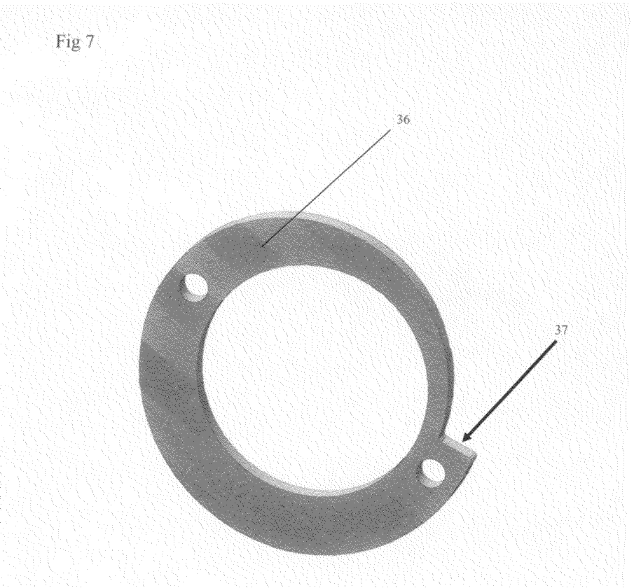

A preferred embodiment of the cam lock 36 is shown in FIG. 7. As shown, the cam lock 36 preferably has a tapered or notched edge 37 so that the locking bar 80 can engage the cam lock 36 to prevent further rotation of the second gear 35 in one direction. Moreover, the tapered edge 37 of the cam lock 36 acts so that the locking bar 80 automatically engages once the cam lock 36 rotates to the notch 37. Preferably, the position where the locking bar 80 engages the notch 37 corresponds to where the vehicle platform 40 is in the raised position. When the locking bar 80 is disengaged, it releases the cam lock 36 and allows rotation of the gear 35. Thus, the platform 40 can be locked into a raised position as shown in FIG. 2a, e.g. for travel, and then subsequently lowered after the locking bar 80 is released, e.g. for arrival and removal of the cargo.

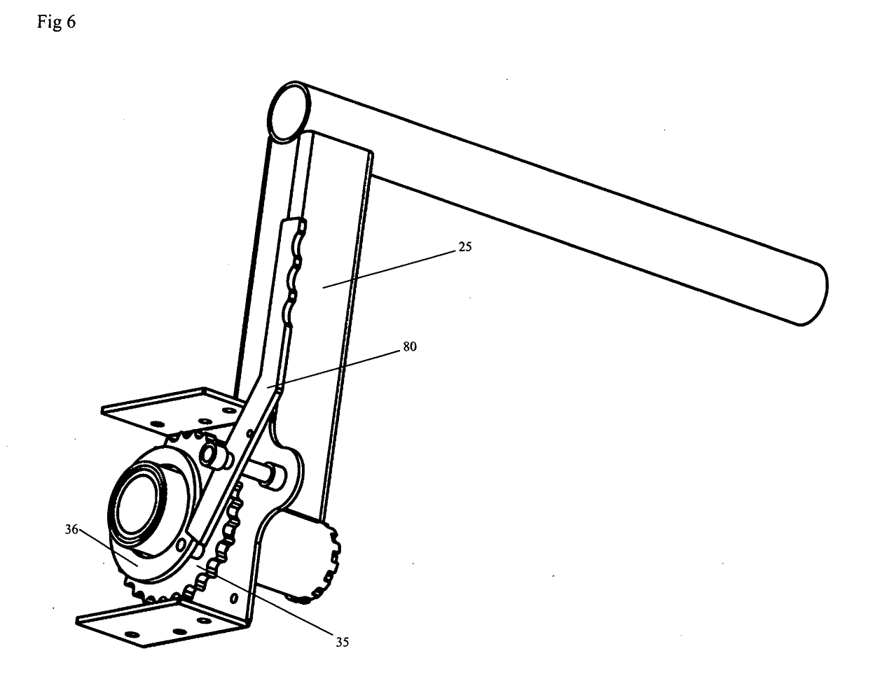

Referring now to FIG. 3, a partial exploded view of a preferred embodiment of the first shaft 30 and first lifting arm 20 is shown. As shown, the lifting arm 20 preferably has a castellated or notched end 22. The castellated end 22 of the lifting arm 20 is preferably tubular and slides over the first shaft 30 to mount. The first shaft 30 preferably has a castellated end 39 and a threaded plate 38. A star plate 65 is preferably inserted into castellated end 22 of the lifting arm 20 and the castellated end 39 of the shaft 30 to align both castellated ends 22 and 39. The star plate 65 is then preferably bolted or otherwise attached to the threaded plate 38 to affix the above parts together such that when the first shaft 30 rotates, it rotates the lifting arm 20 as well. A front view of a preferred embodiment of the first lifting arm 20 attached to the first shaft 30 by, inter alia, the star plate 65 is shown in FIG. 4. A front view of a preferred embodiment of the star plate 65 is shown in FIG. 5. Thus, the lifting arms 20 and 25 can be affixed to the shafts 30 and 31 and rotated to lift the vehicle platform 40.

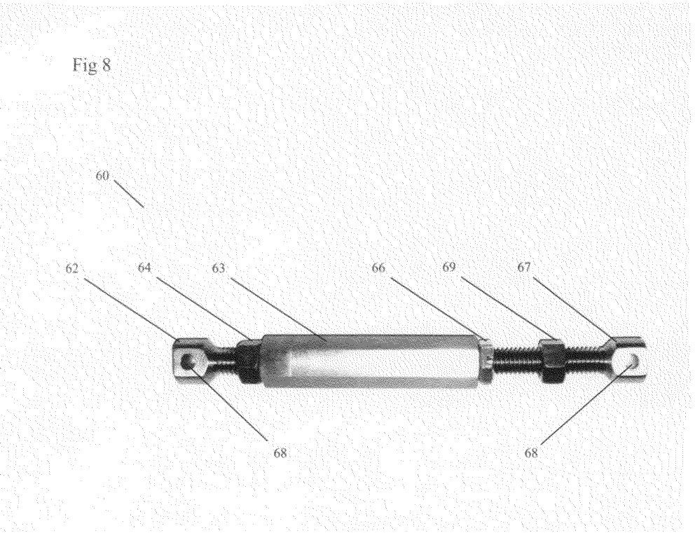

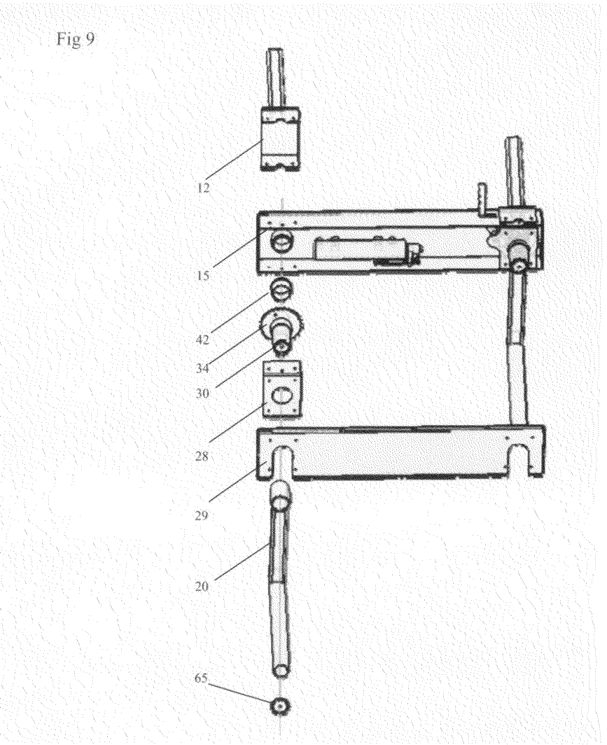

Referring now to FIG. 8, a perspective view of a preferred embodiment of an adjustment rod 60 (or 61) is shown. The adjustment rod 60 preferably comprises a first adjustment bolt 62 with a left hand (LH) thread and a second adjustment bolt 67 with a right hand (RH) thread where each is threaded into an adjoining threaded bar nut 63. Preferably, the first adjustment bolt 62 is threaded through a stop nut (LH) 64 and the second adjustment bolt 67 is threaded through a stop nut (RH) 69 and a jam nut (RH) 66. The first adjustment bolt 62 and the second adjustment bolt 67 each have chain link ports 68 so that segments of the chain 50 can be attached to the adjustment rod 60 at each end via a master link (not shown). As discussed above, the chain 50 preferably comprises two segments 52 and 54 and two adjustment rods 60 and 61 preferably join the segments. By adjusting the adjustment bolts 62 and 67 into and out of the adjoining threaded bar nut 63 while the adjustment rod 60 is attached to the chain segments 52 and 54, the tension and timing of the chain can be adjusted to reduce slippage and fit the chain 50 properly to the gears 34 and 35. Furthermore, the arm 72 of the drive 70 can be attached to the adjustment rod 60 or 61 by placing an end of the arm 72 between the stop nut 69 and the jam nut 66 and tightening the nuts 69 and 66. Thus, the arm 72 can move the chain 50 when attached to the adjustment rod 60 or 61.

Referring now to FIG. 9, a partial exploded view of a preferred embodiment of the invention 10 in a vehicle mount configuration is shown (except the chain is not shown for clarity.) In FIG. 9, the drive box 15 comprises a faceplate 29 to cover the gears 34 and 35 and other moving parts. The drive box 15 also further comprises hub mounts 28 to add stability to the gear assemblies. The drive box 15 shown in FIG. 9 also comprises vehicle mounts 12 preferably for mounting the invention to the rear of a vehicle not shown. In a shop stand configuration, the vehicle mounts 12 would preferably be replaced with the shop stand 100 shown in FIG. 1 and the drive box 15 would be mounted thereto.

Thus, an improved vehicle lift is described above that has an improved locking feature, an adjustable chain drive and rotating arms. In each of the above embodiments, the different positions and structures of the present invention are described separately in each of the embodiments. However, it is the full intention of the inventors of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A vehicle lift comprising:
a vehicle platform supported by at least two lifting arms;
a first lifting arm mounted to a first gear and a second lifting arm mounted to a second gear, where said gears are joined by a chain; and,
a drive attached to the chain such that when an arm of the drive is moved, the chain is moved and the gears and lifting arms are rotated to move the vehicle platform.

2. The vehicle lift of claim 1 where the chain comprises a plurality of links and is adjustable by at least one adjustment rod between two links of the chain, said adjustment rod comprising a first adjustment bolt and a second adjustment bolt inserted into an adjoining nut.

3. The vehicle lift of claim 1 where the first lifting arm is mounted to a first shaft on the first gear and where the shaft has a first castellated end and the lifting arm has a second castellated end and where the shaft and arm are joined by a star plate attached to the shaft and fitting within the first and second castellated ends.

4. The vehicle lift of claim 1 further comprising a locking bar and where one of the gears further comprises a cam lock that rotates to engage the locking bar.

5. The vehicle lift of claim 1 where the first and second lifting arms rotate in lifting arm mounts on the vehicle platform.

6. A vehicle lift comprising:
a vehicle platform supported by a first lifting arm and a second lifting arm;
the first lifting arm is mounted to a first shaft attached to a first gear;
the second lifting arm is mounted to a second shaft attached to a second gear;
a chain having a plurality of links, where the plurality of links engage the teeth of the first gear and the teeth of the second gear;
a ram having an arm, where the arm is attached to the chain such that when the arm extends the chain is moved and the first and second gears are rotated which rotate the first and second lifting arms and said arms lift the vehicle platform.

7. The vehicle lift of claim 6 where the chain comprises two segments, each having a first end and a second end, where the first ends are joined by a first adjustment rod and the second ends are joined by a second adjustment rod.

8. The vehicle lift of claim 7 where the first and second adjustment rods adjust the tension of the chain.

9. The vehicle lift of claim 6 where the first lifting arm is mounted to a first shaft on the first gear and where the first shaft has a first castellated end and the first lifting arm has a second castellated end and where the shaft and arm are joined by a star plate attached to the shaft and fitting within the first and second castellated ends.

10. A vehicle lift comprising:
a vehicle platform supported by a first lifting arm and a second lifting arm;
the first lifting arm is mounted to a first shaft attached to a first gear;
the second lifting arm is mounted to a second shaft attached to a second gear;
a chain having a plurality of links, where the plurality of links engage the teeth of the first gear and the teeth of the second gear;
a hydraulic ram having an arm, where the arm is attached to the chain such that when the arm extends the chain is moved and the first and second gears are rotated which, in turn, rotate the first and second lifting arms and said arms lift the vehicle platform.

11. The vehicle lift of claim 10 further comprising a locking bar and where one of the gears has a tapered cam lock mounted on the gear and that rotates to engage the locking bar.

12. The vehicle lift of claim 10 where the chain comprises two segments, each segment having a first end and a second end, where the first ends are joined by a first adjustment rod and the second ends are joined by a second adjustment rod.

13. The vehicle lift of claim 12 where the first adjustment rod comprises a first adjustment bolt and a second adjustment bolt inserted into an adjoining nut.

14. The vehicle lift of claim 10 where the first shaft has a first castellated end and the first lifting arm has a second castellated end and where the shaft and arm are joined by a star plate attached to the shaft and fitting within the first and second castellated ends.

15. The vehicle lift of claim 10 further comprising a vehicle mount.

16. The vehicle lift of claim 10 further comprising a shop stand.
